(19) United States
(12) Patent Application Publication
(10) Pub. No.: US 2004/0067470 A1
(43) Pub. Date: Apr. 8, 2004

(54) Associative learning cards

(76) Inventor: Michael John Morris, Norwalk, CT (US)

Correspondence Address: TOPE-MCKAY & ASSOCIATES, 23852 PACIFIC COAST HIGHWAY #311, MALIBU, CA, 90265, US

(21) Appl. No.: 10/268,067

(22) Filed: Oct. 8, 2002

(51) Int. Cl. G09B 1/00

(52) U.S. Cl. 434/159

(57) ABSTRACT

A plurality of learning cards used to teach the meaning of a character by associating the character with an associative element is presented herein. The associative learning cards include a character and an associative element affixed to each of the card. The associative element bears a sensory relationship to the character. A user of the cards experiences the sensory features of the associative element and associates the element and the features with the character. The associative learning cards may be arranged into a deck of cards to allow for convenient use and storage.

### BACKGROUND OF THE INVENTION

(1) Technical Field

The present invention relates to tools for facilitating associative learning. More specifically, the present invention presents techniques for teaching children to associate words, letters and characters with related symbols, smells and other sensory elements.

(2) Discussion

Educational tools and games are useful for teaching new concepts and associations to children and to those seeking educational advancement. Since many children and adults enjoy playing card games, these tools provide a particularly enjoyable way of learning.

Existing card-based educational games include “flash cards” that have multiplication problems and answers imprinted on the cards. Cards that have relevant text imprinted on them have also been used to for vocabulary improvement, for assisting in the memorization of verses, and for learning foreign languages.

Unfortunately, many of these educational games require at least two players. For instance, some educational games involve matching one player's cards with the cards of another player, such as in one game where multiple players are each dealt a hand of cards inscribed with unique pictures or symbols. One player then puts down a card and a second player attempts to match the card with a card bearing a like picture or symbol from his or her own hand.

Other educational games use a game board and cards having a variety of symbols or phrases that direct a player's moves on the game board. For instance, in one such game, an instructor one reads text inscribed on a card and then matches the text with an appropriate square on the playing board, with the ultimate goal of matching all of the squares in a row on the game board.

In addition, current educational games are generally designed to visually teach associations between written words, or between written or pictorial symbols and written words. As such, these games are strictly visual in nature, and seldom involve other learning styles. Thus, not only do they fail to take advantage of the user's other senses (e.g., smell, touch, and hearing), but they also put individuals who are strong learners in non-visual styles at a considerable disadvantage. Current educational games that have attempted to include non-visual learning features pose a safety risk in that a child or inexperienced user may try to remove the non-visual feature from the card and use it in an inappropriate manner.

Accordingly, there exists a need in the art for an easy-to-use educational tool that safely promotes learning by associating a character or symbol with a picture, scent, or other associative element. There is also a need for a learning tool that can meet the aforementioned requirements in a cost-effective and convenient manner.

### SUMMARY OF THE INVENTION

The present invention provides for useful and novel associative learning cards that allow a user to learn a character by associating the character with an association element.

It is a feature of the invention to provide a card card-shaped learning apparatus that has at least one character to be learned and at least one associative element which is attached in between the front and the back side of the card, and is exposed on the front and/or back side of the card. This associative element bears a sensory relationship to the character, and thus reinforces the association of the character with the associative element.

In one aspect of the invention, the character may be an alphabetical letter corresponding to a first letter of a word describing the associative element, a word corresponding to the associative element, a picture of an object or being, or a number.

In another aspect, the associative element may be: 1) a figure having a number of components equal to the number of the character; 2) a scent-producing element whereby when a user scratches the scent-producing element, the scent-producing element emits a scent characteristic of the character; 3) a raised element having a tactile composition associated with the character, a sound-producing element, whereby the sound producing element produces a sound characteristic of the character, 4) a magnetic element, or 5) a pictorial representation affixed to the card.

A further aspect of the invention provides for representation of the character and the associative element on opposite sides of the card-shaped learning apparatus. In an alternative aspect, the character and the associative element are represented on one side of the card-shaped learning apparatus.

In an additional aspect, the front and back sides of the cards may be able to be separated so that further exposure of the associative element is possible.

The invention also provides for an associative learning deck that has a plurality of cards where each card is comprised of a front side and a back side, at least one unique character depicted on at least one of the front and back sides; and at least one unique associative element bearing a sensory relationship to the character which is affixed in between the front and back side and exposed on the front and/or back side.

In one aspect, the associative element on each card in the deck of cards may be: 1) a figure having a number of components equal to the number of the character; 2) a scent-producing element whereby when a user scratches the scent-producing element, the scent-producing element emits a scent characteristic of the character; 3) a raised element having a tactile composition associated with the character, a sound-producing element, whereby the sound producing element produces a sound characteristic of the character; 4) a magnetic element; or 5) a pictorial representation.

A further aspect provides for a deck of cards in which a character on each of the cards in the deck may be an alphabetical letter corresponding to a first letter of a word describing the associative element, a word corresponding to the associative element, a picture of an object or being, or a number.

The deck of cards may also have associative elements and characters on each of the cards which provide associations that are different from associations on other the cards in the deck of cards.

The present invention also relates to a method for teaching an association between an associative element and a character, where the method comprises the steps of: 1) viewing a card with at least one character and at least one associative element affixed to the card wherein the associative element bears a sensory relationship to the character; 2) associating sensory characteristics of the associative element with the character; and 3)learning the character by associating the character with the associative element.

In another aspect, the method of associating a character with an associative element includes the steps of: 1) scratching the associative element to emit a scent characteristic of the character; 2) smelling the scent produced by the associative element; and 3) associating the sensory characteristics of the associative element with the character, wherein the sensory characteristics include a scent characteristic of the character.

In a further aspect, the method of associating a character with an associative element includes the steps of touching the associative element, wherein the associative element has a tactile composition characteristic of the character; and associating the sensory characteristics of the associative element with the character, wherein the sensory characteristics include at least one tactile composition characteristic of the character.

The method of associating a character with an associative element also includes, in another aspect, the steps of reading and understanding the associative element and associating the sensory characteristics of the associative element with the character, wherein the sensory characteristics include at least one visual and conceptual aspect characteristic of the character.

An additional aspect of the method of associating a character with an associative element provides for peeling back at least one of two card-shaped pieces of material forming the card to further expose the associative element and associating the sensory characteristics of the associative element with the character.

Additionally, in even further aspect, the method of associating a character with an associative element includes the steps of: 1) viewing the associative element on the card; 2) flipping the card over; 3) viewing the character on an opposite side of the card; and 4) associating the sensory characteristics of the associative element on the opposite side of the card with the character.

The invention also provides for stacking a card on other cards into a deck of cards for use and storage.

### BRIEF DESCRIPTION OF THE DRAWINGS

The objects, features and advantages of the present invention will be apparent from the following detailed descriptions of the preferred aspect of the invention in conjunction with reference to the following drawings where:

FIG. 1(a) is a front perspective view of the front side of an associative learning card having an associative element which is a sound-producing element as wells as a raised element having a tactile composition, and a back elevation view of the back side of the card having a character which is a word;

FIG. 1(b) is a front elevation view of an associative learning card having an associative element that is a scent-producing element and a character which is a picture;

FIG. 1(c) is a front elevation view of an associative learning card having an associative element which is a figure having a number of components equal to the character which is a number; and

FIG. 1(d) is a front elevation an associative learning card having an associative element which is a pictorial representation of a character which is an alphabetical letter corresponding to a first letter of a word describing the associative element;

FIG. 2 is a side perspective view of on aspect of associative learning cards stacked on top of one another, forming a deck of cards; and

FIG. 3 is a process flow diagram of a method by which a user of associative leaning cards learns a character by associating sensory characteristic of an associative element with the character.

### DETAILED DESCRIPTION

The present invention relates to tools used to facilitate associative learning. More specifically, the present invention presents techniques for teaching children to associate words, letters and characters with related symbols, smells and other sensory elements. The following description, taken in conjunction with the referenced drawings, is presented to enable one of ordinary skill in the art to make and use the invention and to incorporate it in the context of particular applications. Various modifications, as well as a variety of uses in different applications, will be readily apparent to those skilled in the art, and the general principles defined herein, may be applied to a wide range of aspects. Thus, the present invention is not intended to be limited to the aspects presented, but is to be accorded the widest scope consistent with the principles and novel features disclosed herein. Furthermore it should be noted that unless explicitly stated otherwise, the figures included herein are illustrated diagrammatically and without any specific scale, as they are provided as qualitative illustrations of the concept of the present invention.

In order to provide a working frame of reference, first a glossary of terms used in the description and claims is given as a central resource for the reader, followed by a discussion of various physical aspects of the present invention which further provides an understanding of the specific details of the invention.

(1) Glossary

Before describing the specific details of the present invention, a centralized location is provided in which various terms used herein and in the claims are defined. The glossary provided is intended to provide the reader with a general understanding of the intended meaning of the terms, but is not intended to convey the entire scope of each term. Rather, the glossary is intended to supplement the rest of the specification in more accurately explaining the terms used.

Association element—The association element may be a figure, illustration or other object that exhibits a sensory feature. Non-limiting examples of an “association element” include elements which possess at least one of the following features: a “scratch and sniff” element, a sound-producing element, and a picture having a visual and or/texture component (e.g., fur in a case where a cat is the character), which is representative of a feature of the character to which the “association element” is associated.

Character—The term “character” as used with respect to this invention generally means a symbol, character, alphabetical mark, numerical mark, picture, or other representation. Non-limiting examples of a “character” include a word, a letter, a number, and a picture.

(2) Physical Aspects

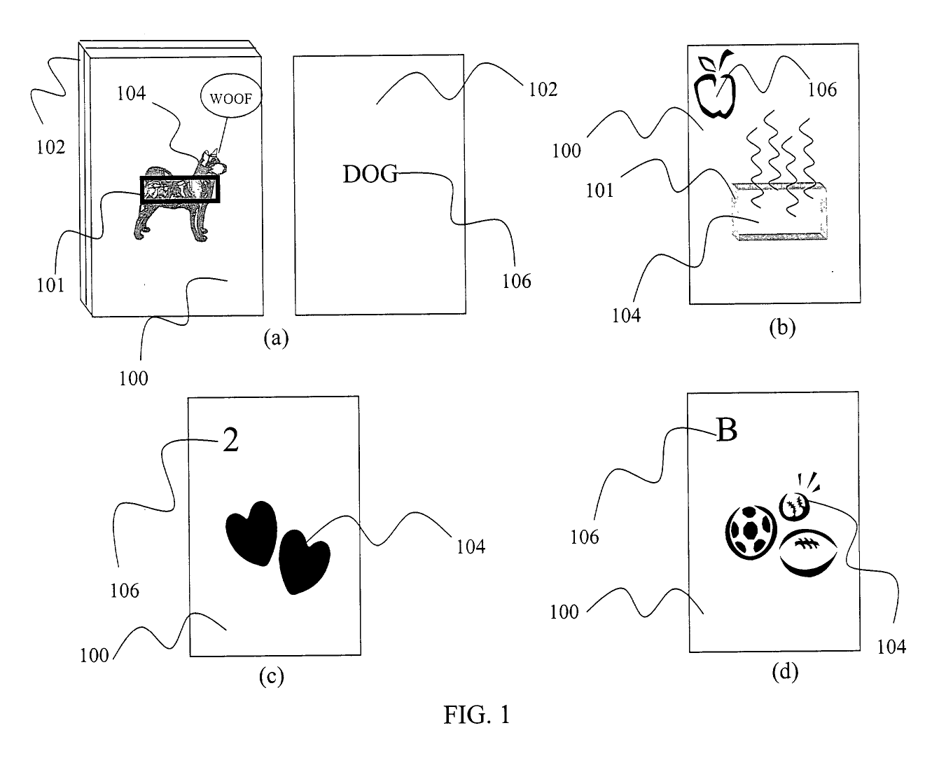

Front views of various aspects of an associative learning card are presented in FIG. 1. In one aspect, shown in FIG. 1(a), an associative learning card has both a front side 100 and a back side 102. Both the front side 100 and the back side 102 of the associative learning card are formed from one of at least one of two card-shaped pieces of material that form the card-shaped learning apparatus. At least one of the pieces of material forming the front side 100 or the back side 102 includes an opening 101 which allows for the exposure of at least a portion of the associative element 104. The associative element 104 bears a sensory relationship to a character 106 and, at least a portion of the associative element 104 is attached in between the at least two pieces of card-shaped material. In the event a user attempts to detach and/or inappropriately use the associative element 104, the attachment of the associative element 104 in between the front side 100 and the back side 102 of the card provides for an additional safety. The card-shaped pieces of material forming the front side 100 and the back side 102, however, may be able to be separated, thus allowing for further exposure of a at least a portion of the associative element 104.

The associative element 104 may, for example, bear a tactile relationship with the character, such as in the case shown, where the character 106 is the word “DOG.” In such an instance, it may be desirable for the dog-shaped associative element 104 to include fur or fuzz which is attached between the at least two pieces of material forming the front side 100 and the back side 102 of the associative learning card to add a tactile composition element to the learning process. The associative element 104 may include other features such as a sound-producing element (e.g., a sound chip, a pressure-based noise-making device, etc.) to provide an audio output when the associative element 104 is touched. In another example, where the character 106 is the word “CAT,” the associative element 104 could be a fuzzy picture of a cat, where the cat makes a purring sound when touched.

Additional portions of the associative element 104 that are not attached in between the at least two pieces of material forming the front side 100 and the back side 102 of the card-shaped learning apparatus may extend onto the surface of the front side 100 or the back side 102. For example, as shown in FIG. 1(a), the furry or fuzzy portion of the dog is attached within the two card-shaped pieces of material forming the front side 100 and the back side 102 of the card-shaped learning apparatus, and viewable and touchable through the opening 101 in the front side 100. The remainder of the dog is a pictorial representation which extends onto the front side 100 of the card-shaped learning apparatus. A further example is such that where the character 106 is the letter “D,” the character 106 could be a dinosaur, where a portion of the dinosaur includes leathery skin which is attached between the at least two pieces of card-shaped material forming the front side 100 and the back side 102. This leathery skin portion of the associative element 104 is visible and touchable through an opening 101 in at least one of the two pieces of card-shaped material while the remainder of the dinosaur may be drawn on the front side 100 or the back side 102 of the card-shaped learning apparatus. The dinosaur may “roar” or growl” when the leathery portion is touched by a user.

In FIG. 1(b), the associative element 104 is a scent-producing element, which emits a scent to assist the user in developing a mental association between the character 106 and the associative element 104. In the specific instance shown, the character 106 is a picture of an apple, and the scent-producing element is a “scratch-and-sniff” pad that releases an apple-like scent when scratched or rubbed by a user.

Another aspect of the associative learning card is presented in FIG. 1(c), where the character 106 is represented as a number, and where the associative element 104 is a figure having a number of components (heart shapes in the case shown). The number of components included in figure is equal to the number represented by the character 106. Since the number of components (two) is equal to the numerical value number, cards designed in this manner can be used to help develop a user's association of quantities with their symbolic representations.

A further aspect of the invention is shown in FIG. 1(d), in which the associative element 104 is in the form of a pictorial representation of a character, and in which the character 106 is a letter. In the case shown, the associative element 104 is a group of balls used in various sporting activities and the character is the letter “B.” In this case, the association to be developed is between the letter “B” and a pictorial representation of a word that starts with the letter “B.”

It is also an aspect of the invention to have an associative element 104 which is a magnetic element (not shown). For instance, the associative element 104 may be a magnet that affixed to the card and the user can remove the magnet from the card for manipulation of the associative element's shape and size and/or for closer comparison to the character.

The associative learning cards depicted in FIGS. 1(a)-(d) may be of a wide variety of colors, shapes, and sizes and may include associative elements 104 and characters 106 that are of various colors, shapes and sizes.

Additionally, an associative learning card may have any combination of one or more characters 106 and one or more associative elements 104. In a further aspect of the invention, the associative learning card 102 has more than one character 104 and/or more than one associative element 106 affixed within the card-shaped learning apparatus.

The associative learning cards provided by the invention may also include a character 106 and an associative element 104 which are represented on the same side of the associative learning card 102. Alternatively, at least one character 106 and one associative element 104 may be represented on opposite sides of the associative learning card.

A wide variety of papers, cardboards, cardstocks, plastics and other similar materials may be used to make the associative learning cards of many shapes, sizes and colors. The characters 106 and associative elements 106 may be made from a wide variety of inks, plastics, papers, scented oils, visually, stimulating, textually-stimulating and/or other materials of a variety of colors and sizes. Furthermore, imprinting, embossing, gluing, fastening, and other forms of attachment are possible manners of affixing the depicted character 106 and the associative element 104 to and within the card-shaped learning apparatus, and will be appreciated by those of skill in the art.

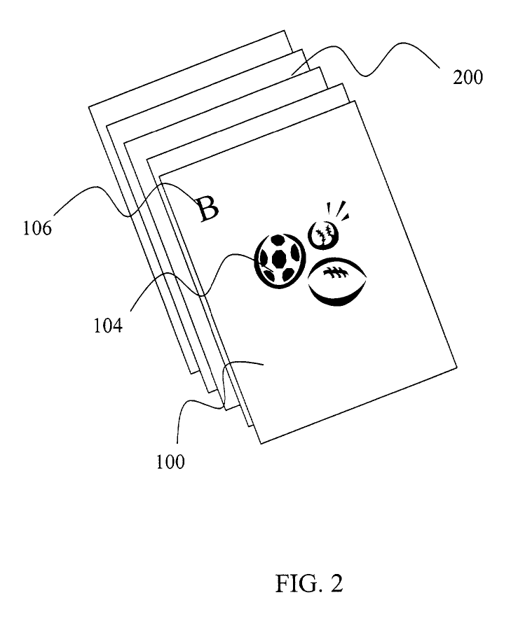

FIG. 2 provides a perspective view of a deck 200 comprising a plurality of the cards shown in FIGS. 1(a)-1(d). Each associative learning card in the deck 200 includes at least one associative clement 104 that bears a sensory relationship to a character 106. As shown in FIG. 2, the top associative learning card in the deck 200 includes an associative element 104 in the form of a pictorial representation of “balls,” and a corresponding character 106 in the form of the letter “B.” The deck 200 also aids in teaching quantitative relationships and further provides for convenient use and storage of the associative learning cards.

In one aspect of the invention, the deck 200 consists of associative learning cards that have characters 106 and associative elements 104 that are unique but similar in form. For instance, non-limiting examples include a deck 200 comprised of associative learning cards having characters 106 that are all letters and associative elements 104 that are all pictorial representations, or a deck 200 having characters 106 that are all pictures and associative elements that are all scent-producing elements.

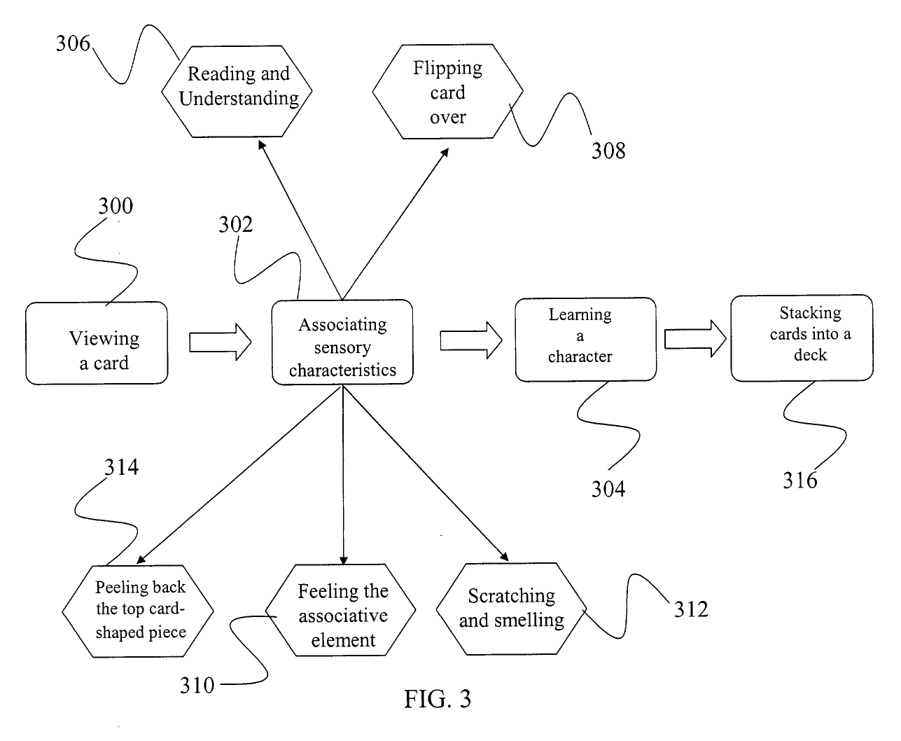

FIG. 3 is a flow diagram of a method of using associative learning cards to learn a character 106 by associating it with an associative element 106. A user of an associative learning card learns a character 104 by engaging in the steps of: (1) viewing an associative learning cards 300 having at least one character 104 and at least one associative element 106 affixed to the card; (2) associating sensory characteristics 302 of the associative element 106 with the character 104; and (3) learning the character 304.

The step of associating sensory characteristics of the associative element 104 with the character 106 may be comprised of non-limiting sub-steps which include: reading and understanding 306 the associative element 104; flipping the associative learning card over 308 and viewing a character 106 on an opposite of the associative learning card; touching the associative element 104 and feeling a tactile composition 310 characteristic of the character 104; and scratching and smelling 312 the associative element 104, peeling back 314 the at least one card-shaped piece of material forming the front or the back side of the card to expose the sensory characteristics of the associative element 104, and smelling a scent produced by the associative element 104 which is characteristic of the character 104. The user of the associative leaning card may also engage in the step of stacking the cards 316 into a deck 200 in order to provide for convenient use and storage of the card.

What is claimed is:

1. A card-shaped learning apparatus comprising:
A plurality of card-shaped pieces of material wherein at least one of the card-shaped pieces forms a front side and at least one of the card shaped pieces forms a back side of the apparatus, and at least one of the front side and the back side includes an opening;
at least one character depicted on at least one of the front and back sides; and
at least one associative element, affixed between the front and back sides, wherein at least a portion of the associative element is exposed through the opening and bears a sensory relationship to the character.

2. A card-shaped learning apparatus, as set forth in claim 1, wherein the character is comprised of at least one feature selected from a group consisting of:
an alphabetical letter corresponding to a first letter of a word describing the associative element;
a word corresponding to the associative element;
a picture of an object or being; and
a number.

3. A card-shaped learning apparatus, as set forth in claim 1, wherein the associative element is comprised of at least one feature selected from a group consisting of:
a figure having a number of components equal to a number of the character;
a scent-producing element configured to emit a scent, characteristic of the character when scratched by a user;
a raised element having a tactile composition associated with the character;
a sound-producing element, whereby the sound producing element produces a sound characteristic of the character when accentuated by a user;
a magnetic element; and
a pictorial representation affixed to the piece of material.

4. A card-shaped learning apparatus, as set forth in claim 2, wherein the associative element is comprised of at least one feature selected from a group consisting of:
a figure having a number of components equal to a number of the character;
a scent-producing element configured to emit a scent, characteristic of the character, when scratched by a user;
a raised element having a tactile composition associated with the character;
a sound-producing element, whereby the sound producing element produces a sound characteristic of the character when accentuated by a user;
a magnetic element; and
a pictorial representation affixed to the piece of material. A card-shaped learning apparatus, as set forth in claim 1, wherein the character and the associative element are represented on opposite sides of the apparatus.

6. A card-shaped learning apparatus, as set forth in claim 5, wherein the character is comprised of at least one feature selected from a group consisting of:
an alphabetical letter corresponding to a first letter of a word describing the associative element;
a word corresponding to the associative element;
a picture of an object or being; and
a number.

7. A card-shaped learning apparatus, as set forth in claim 5, wherein the associative element is comprised of at least one feature selected from a group consisting of:
a figure having a number of components equal to a number of the character;
a scent-producing element configured to emit a scent, characteristic of the character, when scratched by a user;
a raised element having a tactile composition associated with the character;
a sound-producing element, whereby the sound producing element produces a sound characteristic of the character when accentuated by a user;
a magnetic element; and
a pictorial representation affixed to the piece of material.

8. A card-shaped learning apparatus, as set forth in claim 6, wherein the associative element is comprised of at least one feature selected from a group consisting of:
a figure having a number of components equal to a number of the character;
a scent-producing element configured to emit a scent, characteristic of the character, when scratched by a user;
a raised element having a tactile composition associated with the character;
a sound-producing element, whereby the sound producing element produces a sound characteristic of the character when accentuated by a user;
a magnetic element; and
a pictorial representation affixed to the piece of material.

9. A card-shaped learning apparatus, as set forth in claim 1, wherein the character and the associative element are represented on one side of the apparatus.

10. A card-shaped learning apparatus, as set forth in claim 9, wherein the character is comprised of at least one feature selected from a group consisting of:
an alphabetical letter corresponding to a first letter of a word describing the associative element;
a word corresponding to the associative element;
a picture of an object or being; and
a number.

11. A card-shaped learning apparatus, as set forth in claim 9, wherein the associative element is comprised of at least one feature selected from a group consisting of:
a figure having a number of components equal to a number of the character;
a scent-producing element configured to emit a scent, characteristic of the character, when scratched by a user;
a raised element having a tactile composition associated with the character;
a sound-producing element, whereby the sound producing element produces a sound characteristic of the character when accentuated by a user;
a magnetic element; and
a pictorial representation affixed to the piece of material.

12. A card-shaped learning apparatus, as set forth in claim 10, wherein the associative element is comprised of at least one feature selected from a group consisting of:
a figure having a number of components equal to a number of the character;
a scent-producing element configured to emit a scent, characteristic of the character, when scratched by a user;
a raised element having a tactile composition associated with the character;
a sound-producing element, whereby the sound producing element produces a sound characteristic of the character when accentuated by a user;
a magnetic element; and
a pictorial representation affixed to the piece of material.

13. A card-shaped learning apparatus, as set forth in claim 1, wherein the card-shaped pieces of material are separable thereby providing further exposure of the associative element.

14. A card-shaped learning apparatus, as set forth in claim 13, wherein the character is comprised of at least one feature selected from a group consisting of:
an alphabetical letter corresponding to a first letter of a word describing the associative element;
a word corresponding to the associative element;
a picture of an object or being; and
a number.

15. A card-shaped learning apparatus, as set forth in claim 13, wherein the associative element is comprised of at least one feature selected from a group consisting of:
a figure having a number of components equal to a number of the character;
a scent-producing element configured to emit a scent, characteristic of the character, when scratched by a user;
a raised element having a tactile composition associated with the character;
a sound-producing element, whereby the sound producing element produces a sound characteristic of the character when accentuated by a user;
a magnetic element; and
a pictorial representation affixed to the piece of material.

16. An associative learning deck comprising:
a plurality of cards wherein each card is comprised of at least two card-shaped pieces of material wherein at least one of the card-shaped pieces of material forms a front side and at least one of the card shaped pieces of material forms a back side, and at least one of the front side and the back side includes an opening;
at least one unique character depicted on at least one of the front and back sides; and
at least one unique associative element, affixed between the front and back sides, wherein at least a portion of the associative element is exposed through the opening and bears a sensory relationship to the character.

17. An associative learning deck, as set forth in claim 16 wherein the associative element and the character are represented on opposite sides of at least one of the cards in the plurality of cards.

18. An associative learning deck, as set forth in claim 16, wherein the associative element and the character are represented on one side of at least one of the cards in the plurality of cards.

19. An associative learning deck, as set forth in claim 16, wherein the character is comprised of at least one feature selected from a group consisting of:
an alphabetical letter corresponding to a first letter of a word describing the associative element;
a word corresponding to the associative element;
a picture of an object or being; and
a number.

20. An associative learning deck, as set forth in claim 16, wherein the associative element is comprised of at least one feature selected from a group consisting of:
a figure having a number of components equal to a number of the character;
a scent-producing element configured to emit a scent, characteristic of the character, when scratched by a user;
a raised element having a tactile composition associated with the character;
a sound-producing element, whereby the sound producing element produces a sound characteristic of the character when accentuated by a user;
a magnetic element; and
a pictorial representation.

21. An associative learning deck, as set forth in claim 16, wherein the associative element and the character on each of the cards provide associations different from associations on other the cards in the deck of cards.

22. An associative learning deck, as set forth in claim 16, wherein the card-shaped pieces of material are separable thereby providing further exposure of the associative element.

23. A method for teaching an association between an associative element and a character, the method comprising steps of:
viewing a card with at least one character and at least one associative element affixed to the card wherein the associative element bears a sensory relationship to the character;
associating sensory characteristics of the associative element with the character; and
learning the character by associating the character with the associative element.

24. A method of associating a character with an associative element as set forth in claim 23, further comprising steps of:
scratching the associative element to emit an scent characteristic of the character;
smelling the scent produced by the associative element and associating the sensory characteristics of the associative element with the character, wherein the sensory characteristics include a scent characteristic of the character.

25. A method of associating a character with an associative element as set forth in claim 23, further comprising steps of:
touching the associative element, wherein the associative element has a tactile composition characteristic of the character; and
associating the sensory characteristics of the associative element with the character, wherein the sensory characteristics include at least one tactile composition characteristic of the character.

26. A method of associating a character with an associative element as set forth in claim 23, further comprising steps of:
reading and understanding the associative element; and
associating the sensory characteristics of the associative element with the character, wherein the sensory characteristics include at least one visual and conceptual aspect characteristic of the character.

27. A method of associating a character with an associative element as set forth in claim 23, further comprising steps of:
viewing the associative element on the card;
flipping the card over;
viewing the character on an opposite side of the card; and
associating the sensory characteristics of the associative element on the opposite side of the card with the character.

28. A method of associating a character with an associative element as set forth in claim 23, further comprising steps of:
peeling back at least one of two card-shaped pieces of material forming the card;
further exposing the associative element; and
associating the sensory characteristics of the associative element with the character.

29. A method of associating a character with an associative element as set forth in claim 23, further comprising steps of associating an associative element that is affixed between a front side and a back side of the card with the character, wherein at least a portion of the associative element is exposed through the opening on at least one of the front side and the back sides.

30. A method of associating a character with an associative element as set forth in claim 23, further comprising a step of stacking the card on other cards into a deck of cards for use and storage.
